(19) United States
(12) Patent Application Publication
(10) Pub. No.: US 2021/0295081 A1
(43) Pub. Date: Sep. 23, 2021

(54) TRACKING AND ANALYTICS SYSTEM

(71) Applicant: Perceive Inc, Fishers, IN (US)

(72) Inventors: Everett Patrick BERRY, Fishers, IN (US); Aaron James MICHAUX, Lancaster, PA (US); Samuel Joseph ESCHKER, Indianapolis, IN (US); Matthew P. WOENKER, Lynchburg, VA (US)

(21) Appl. No.: 16/824,478

(22) Filed: Mar. 19, 2020

(51) Int. Cl. G06K 9/32; G06K 9/00; G06T 7/593; G06K 9/46; G06T 7/80

(52) U.S. Cl. CPC G06K 9/3233; G06K 9/00771; G06T 7/85; G06K 9/4642; G06K 9/00369; G06T 7/593

(57) ABSTRACT

A computer-implemented tracking method and system that accesses images of a three-dimensional space captured by a stereo camera is presented. The method generates a three-dimensional computer model of the space, generates a two-dimensional semantic map of the space based on the three-dimensional computer model, receives user criteria via a user interface that includes a presentation of a room map, and extracts visitor tracks in the space of interest from the images and determining if the user criteria is fulfilled. The method and system generates statistics pertaining to behavior or users in a space, such as a museum or a store.

### RELATED FIELD

This disclosure generally relates to a method and system of tracking a person through a three-dimensional space, and more specifically to a method of tracking using three-dimensional camera systems that are able to synthesize the floor plan of a locale from the combination of multiple camera views.

### BACKGROUND

The internet has revolutionized the way that retail stores do business. Online retailers are able to track or measure every facet of customer behavior, such as which products a customer viewed or bought, which online advertisement a customer hovered over or clicked on, etc.

This way of operating lies in stark contrast to the brick-and-mortar retail industry where retailers can only generate data at the point of sale and lack understanding of behaviors prior to purchase. A way for the brick-and-mortar stores to better understand customer behavior is desired.

### SUMMARY

The inventive concept pertains to a computer-implemented tracking method that accesses images of a three-dimensional space captured by a stereo camera, generates a three-dimensional computer model of the space, generates a two-dimensional semantic map of the space based on the three-dimensional computer model, receives user criteria via a user interface that includes a presentation of a room map, and extracts visitor tracks in the space of interest from the images and determining if the user criteria is fulfilled.

### BRIEF DESCRIPTION OF THE DRAWINGS

FIG. 1A is a flowchart depicting a general overview of an embodiment of the tracking method disclosed herein.

FIG. 1B is a pictorial illustration of a stereo camera, tracks, multiple rooms and calibration object.

FIG. 2 is an example illustration of User Interface including a room map on which a region of interest may be indicated.

FIG. 3 Is an illustration of the overlap overlap region between two camera views and associated uncertainties.

FIG. 4 Is an illustration of the path of a person as observed by cameras.

FIG. 5 Is a flow chart describing the process of turning camera images into tracks.

FIG. 6A is a depiction of a web map application including a semantic map through which regions or targets may be received.

FIG. 6B is a depiction of a region drawing tool available on a user interface.

FIG. 6C is a flowchart depicting the process for retrieving statistics.

FIG. 6D illustrates example of statistics that may be generated and presented on a user interface.

FIG. 7 Is an illustration of the tracking process and gaze cone

FIG. 8 is an illustration of targets as well as a tool for positioning targets.

### DETAILED DESCRIPTION

The disclosure pertains to an improved method and system from tracking the whereabouts of visitors or customers in a locale, and specific regions of interests visitors or customers are looking at within the locale. This disclosure also relates to observing the activity and gaze directions of visitors of a particular location, learning about behaviors of visitors of a space, and gaining associated knowledge. This is particularly useful for operators in a retail space, or a museum, or other public spaces, although there is utility in other locations as well.

Numerous attempts have been made for object tracking on video and other systems to better understand customer behavior patterns and statistics. For example, the method and system described in WO 2017/155466 A1 by Lin XIAOMING and Ravichandran PRASHANTH titled “Method and System for Visitor Tracking at a POS Area” attempts to capture data relating to an individual purchasing a product. However, its utility is strictly limited to the point of sale. This system is not able to track the customer's behavior before he or she came to the cash register.

US 2014/0132728 A1 by Raul Ignacio VERANO, Ariel Alejandro Di STEFANO, and Juan Ignacio PORTA, titled “Methods and Systems for Measuring Human Interaction,” describes measuring interactions in 3D space using a point cloud. However its utility is limited to one sensor in a small area. This particular system describes a collision between a shopper and an object under interest. This system is not able to detect or track the gaze of a shopper, nor can the system cover a large area.

The system described by PIRSIAVASH, H. D. RAMANAN, and C. C. FOWLKES titled “Globally-Optimal Greedy Algorithms for Tracking a Variable Number of Objects” in CVPR 1201-1208 addresses efficiently tracking a variable number of objects by adopting algorithms that are used in network flow problems. This system does not process efficiently for many objects or work over a long period of time. Their system does not use 3D data and does not track in small chunks, but tracks over the whole time period which makes it slow. But I'm also fine to just move this since it could be a small distinction in some eyes.

The system described by Zhang LI, Yuan LI, and R. NEVATIA titled “Global Data Association for Multi-Object Tracking Using Network Flows” in the IEEE Conference on Computer Vision and Pattern Recognition 1-8 is the earliest work in tracking objects with a global cost function using network flow. However, the system described by LI et al. does not stitch multiple camera views together, process many persons efficiently, or make use of 3D information.

The system described by Anton MILAN, Konrad SCHINDLER, and Stefan ROTH titled “Multi-Target Tracking by Discrete-Continuous Energy Minimization” in IEEE Transactions on Pattern Analysis and Machine Intelligence 38 (10): 2054-68 focuses on finding the most smooth tracks, or tracks that use the least energy. This system does not use a global cost function, does not use 3D data, and does not stitch multiple camera views.

The system described by Zhengyang WU, Fuxin LI, and Rahul SUKTHANKAR titled “Robust Video Segment Proposals with Painless Occlusion Handling” in Proceedings of the IEEE Conference on Computer Vision and Pattern Recognition, 4194-4203 focuses on segmenting video while handling occlusions. It does not use 3D geometry to stitch multiple cameras together.

The system described by Andre BARBU, Aaron MICHAUX, Siddharth NARAYANASWAY, and Jeffrey Mark SISKIND titled “Simultaneous Object Detection, Tracking, and Event Recognition”, found at http://arxiv.org/abs/1204.2741. This system is different from ours in that it uses machine learning instead of 3D geometry to track objects. This system proposes to use the Viterbi algorithm to globally solve the tracking problem. This system is different from the disclosure below in the way multiple camera views are stitched together and on the use of 3D data for the fundamentals of tracking.

The system of the disclosure is capable of providing a fast three-dimensional mapping camera system, providing a rigid transformation sequence for switching from floorplan to three-dimensional space to camera space for the purpose of doing analytics, handling full room tracking using geometric error correction, and enabling the user to replay an entire customer visit.

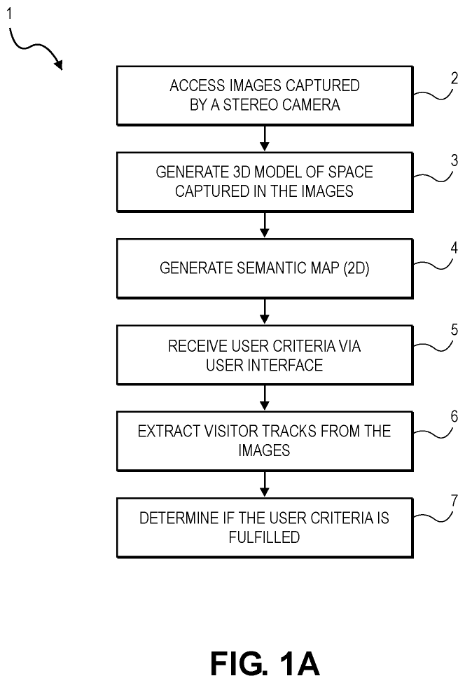

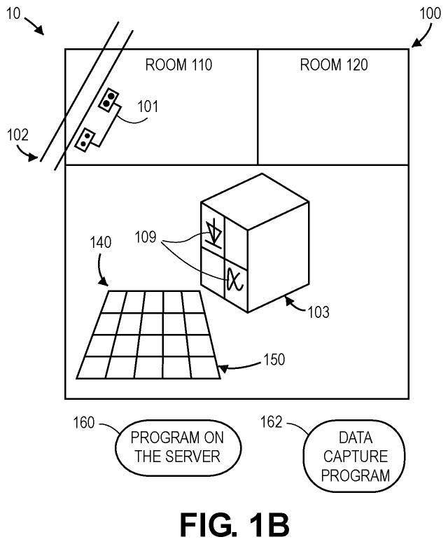

FIG. 1A is a flowchart depicting a general overview of a visitor tracking method 1 in accordance with an embodiment of the present disclosure. As shown, the tracking method 1 entails accessing images that are captured by one or more stereo cameras that are set up in a space (step 2). The stereo cameras capture images and transmit them to a computing device, which generates a three-dimensional model of the space (step 3). Using the three-dimensional model, the computing device generates a two-dimensional semantic map (step 4). The computing device receives user criteria via a user interface, via user input on the semantic map (step 5). The user input may be, for example, a region of interest in the space. Using the images, the computing device tracks the movements of a visitor through the space and any adjoining space that also has cameras for capturing images (step 6). The computing device determines, based on the tracked movements of the visitor, various information of interest about the visitor's behavior relative to the region of interest, such as how long the visitor was at the region of interest, how many time she visited the region of interest, etc. (step 7).

Referring to FIG. 1B, in a first aspect of the tracking system 10, stereo cameras 101 are deployed and used to create a three dimensional model of a space of interest (e.g., a room) or multiple rooms in the space of interest. Stereo cameras, which typically have two or more lenses with separate image sensors or film frames for the lenses, is able to capture three-dimensional images and are commercially available.

### Synthesizing the Rooms

Referring to FIG. 1B, a stereo camera 101 is fitted to a fixture 102 by a user in a site 100. The camera may receive power from the fixture 102, although this is not a limitation of the inventive concept. The camera has been preconfigured with WIFI credentials. The camera connects to the available WIFI and establishes a secure channel to a cloud server. A user, using a computing device (not shown), runs a software program to alert when the channel has been established. The user runs a software program to show a live video view of the camera 101. The user may adjust the camera based on this view. A second stereo camera is placed several meters away in the same fashion. Its view is adjusted so that there is an overlap between its field of vision and the field of vision of the first camera. This area of overlapping field of vision between the two cameras is herein referred to as the “overlap region.” A “computing device,” as used herein, refers to a device having a processor, memory, and a user interface that is capable of executing instructions as described herein.

A calibration object 103 containing multiple calibration patterns 104 occupying a sufficiently large portion of the field of vision is selected. The calibration object 103 is placed in the overlap region between the first and second stereo cameras 101. The computing device initiates a data capture software program that is synchronized between the cameras 101. The computing device runs a second program which tags the positions of each camera 101. This program looks up the calibration settings for each camera and site 100. This program submits the captured data and its other information to a cloud server. A third software program 160 on the server validates that it can register a sufficient number of datapoints from the calibration object. This program calculates the geometry of the scene using the known dimensions of the calibration object 103 and the calibration settings from the camera. Additionally, an auto-calibration may be used where the cameras determine where they are relative to each other by stitching point-clouds according to known methods. Then the program 160 will find the optimal floor plane between cameras by using RANSAC, which is a well-known optimization procedure. The end-user then rotates and translates the final 2D-floor-coordinate system 150. This program produces a rigid transformation. The rigid transformation is applied to 3D points produced by the stereo camera system. Each 3D point is related to a pair of pixels, one in each sensor, with units of meters.

A notification is generated if the cloud calibration program 160 runs successfully and is shown the results. The program 160 is executed with different pairs of cameras in the room by moving the calibration object 103 to new positions. The computing device runs the data capture, information collection, and calibration programs 160 each time. The cloud program 160 keeps track of the additional stereo cameras 101 that are being added to the scene. If a stereo camera 101 is not able to be paired with any other stereo camera 10 in the scene, the cloud program will indicate an error. Often there are situations where a single view cannot be found where every camera can see the calibration object 103. So a graph is built that relates camera positions relative to cube positions, and transitive properties of rigid transformations are utilized to define a single global rigid transformation for each camera. A single global rigid transformation is produced for each position of the calibration object. Finally, an optimization procedure finds the optimal placements for all calibration objects 103 and cameras 101, using all input images. The computing device provides real-time feedback about the placement of objects 103 and cameras 101, enabling the technician to fix any positioning problems. The data capture program 162 will increment a version number if there are errors. The cloud program 160 will keep track of different versions in the same scene.

Different coordinate systems are developed to help capture the scenes and provide a convenient interface for a user to select regions of particular interest in the space.

### Unified Floorplan in Real Units

TABLE 1
Different coordinate systems used in the disclosure

| | |
|---|---|
| Site Coordinate System | A coordinate system in the real physical |
| | space |
| Camera Coordinate System | A coordinate system used by the cameras |
| Scene Coordinate System | A coordinate system in the three-dimensional |
| | scene files; a subset of the space captured by |
| | the system |
| Floor Coordinate System | A coordinate system 150 shown in FIG. 1B |

Referring to Table 1, four different coordinate systems are used in the present inventive concept. A scene file is saved for each site 100. The scene file contains a list of all the cameras in the cumulative space (e.g., an entire store), a version number, metadata, a checksum, rigid transformations for each camera, an additional rigid transformation that can be applied globally and allows the end user to configure the orientation of the floor-space 150 to what is most convenient to her, an origin 140. and the version numbers for each calibration setting for each camera. The computing device generates the scene file when the room was synthesized. The scene file versions correspond to the setup of the cameras. Hence, when the cameras are added, removed, moved, or otherwise changed, a new scene file is created. The scene file relates each camera to every other camera and to the camera coordinate system of the room. The scene file indexes each camera 101 to its calibration settings which are versioned in cloud storage.

The scene file enables a lookup when an image is selected from the camera. Each pixel in the image is mapped into the synthesized 3D space recorded in the scene file using Scene Coordinate System. A meter square grid 150 (Floor Coordinate System) is displayed on select images from the cameras. A person (e.g., a user) can draw, using the software program, regions of interest in the form of arbitrary 2D closed polygons or circles, on the image. These 2D polygons correspond to 3D polygons on the site floor, in the Site coordinate system. This technique enables a semantic understanding of the scene (e.g. a coffee table) to be translated into Scene Coordinate System that has been established during synthesis. This process can also be done using the semantic map.

The sequence consists of the following coordinate systems:

### Site Coordinate System->Camera Coordinate System→Scene Coordinate System→Floor Space Coordinate System

The above four coordinate systems form a rigid transformation sequence for switching between floorplan 150 (Floor Space Coordinate System), 3D space (Site/Scene Coordinate System) to camera space (Camera Coordinate System) for the purpose of performing analytics.

### UI Tool

In one aspect of the system a User Interface (UI) tool is developed to assist users in selecting regions of interest.

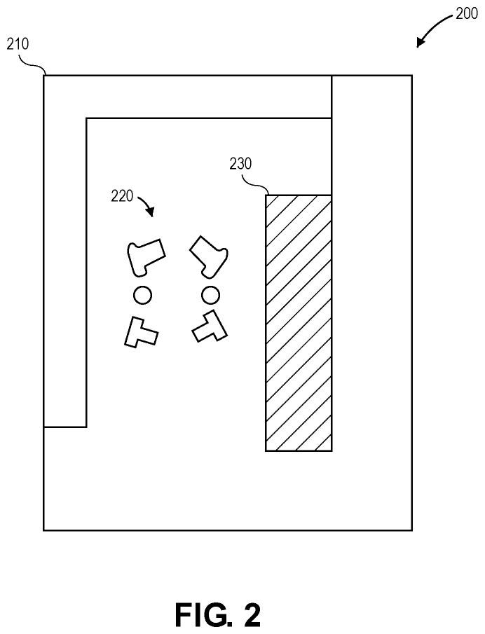

Referring to FIG. 2, a UI tool 200 enables a user to draw regions of interest 230 on a room map 210. The room map 210 is generated, in part, by the software program based on images captured by the stereo cameras 101. The room map 210 may be constructed with input from the users of the system, such as a blueprint of the store. The room map 210 may or may not display furniture 220 or other recognizable elements in the configuration of the room. The scene file implicitly describes an orthographic projection from 3D space onto a 2D floor. The site floor map and 3D map are combined so that the 3D regions of interest are displayed accurately on the room map 210. Likewise, the room map 210 can now be used to draw new regions of interest 230. No specific camera view is required for this process.

### High-Uncertainty Tracking

In another aspect of the system, a method for handling the high uncertainties associated with the data captured from stereo cameras is disclosed.

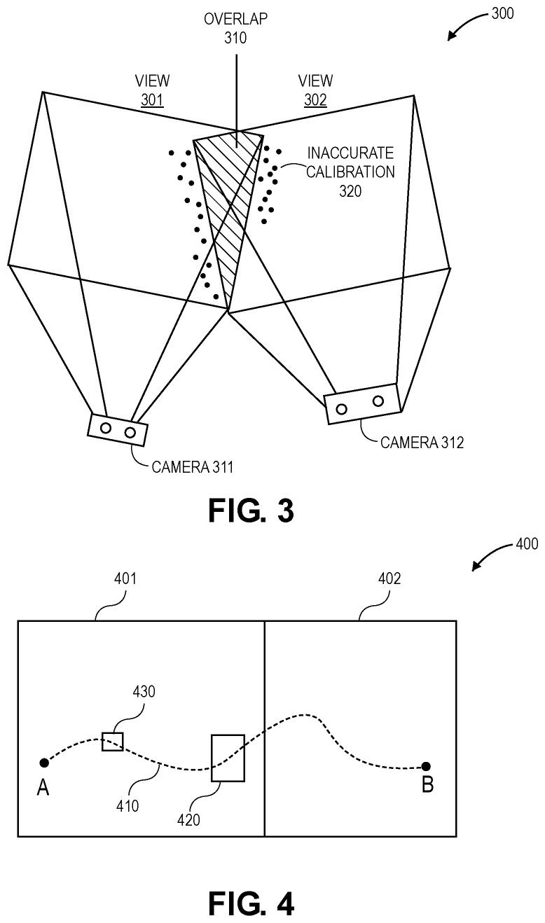

Referring to FIG. 3, two stereo cameras 311 and 312 may observe the same scene 300 and create a view 301 and a view 302. When the two views 301 and 302 have an overlap region 310, then multiple pixels in each view capture the same information. These overlap regions 310 are typically at the edge of the views. Cameras have higher calibration errors at the edge of the view, creating an inaccurate calibration region 320.

Referring to FIG. 4, a tracking process predicts and measures tracks 410 representing the path of people in 3D space from a point A in a room 401 to a point B in a possibly different room 402. Small errors in pixel location at the edges of images (as illustrated in FIG. 3) could lead to large errors in 3D placement and “misses” in the tracking process. Therefore, a correction method is used for the hardware calibration error. In the prediction step, an expanded area 420 is considered in the areas of higher calibration error. A transformation from 3D space to 2D space using the scene file is done. If a person is being tracked into a 3D area which has 2D calibration errors, the correction method makes adjustments. Once a person has exited the area of higher error a reduced prediction space 430 results, providing geometric error correction. Therefore, when connecting tracklets representing a single path across neighboring rooms 401 and 402, a first tracklet is generated in Room 401 with a corresponding first geometry, and a second tracklet is generated in room 402 with a corresponding second geometry. As the first and second tracklets share an overlapping portion, the overlapping portion may correspond to a region of high uncertainty 430 as it pertains to the first tracklet and also another region of lower uncertainty 420 as it pertains to the second tracklet. For the overlapping region, the tracklet portion geometry corresponding to the low uncertainty region 420 will be chosen, or a weighted geometric of the first and second geometries. This correction method is repeated globally for all cameras in a scene.

An individual track represents a person moving across the site floor map (or standing still) over a period of time. A set of tracks has one of more tracks in it.

A track has a 2D floor location at any given point of time. This 2D floor location maps isomorphically to a 3D location on the floor of the site of interest using Camera Coordinate System in captured images. Each 2D floor location, in turn, is related to one or more cameras. The floor location is related to pixel locations in the stereo camera images of those cameras.

Turning Camera Images into Tracks

In another aspect, a process to extract visitor tracks from camera images is disclosed.

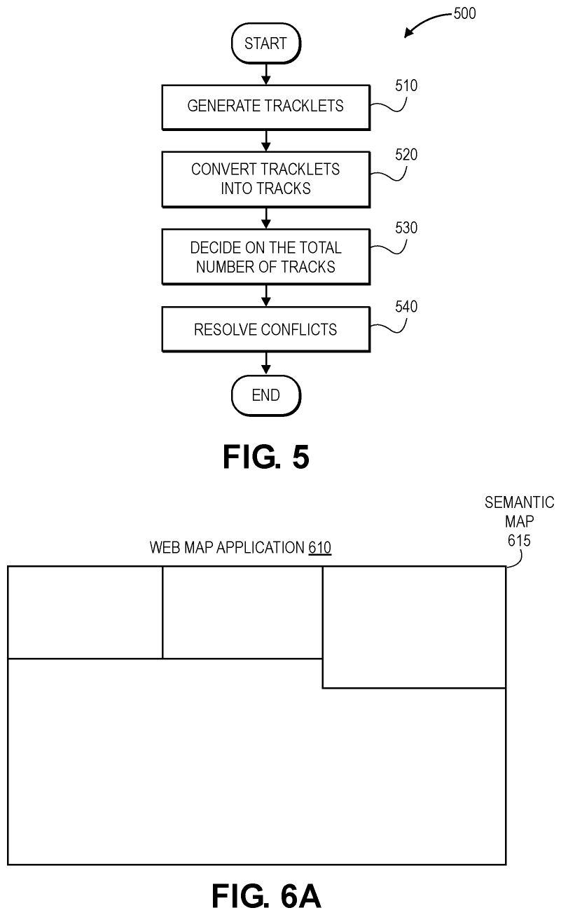

FIG. 5 illustrates the mechanics of the process 500 that turns camera images into tracks. The component processes are as follows and comprise processes to:

generating tracklets 510,

converting tracklets into tracks 520,

deciding on the total number of tracks 530, by using a cost function term considering spatial proximity, and an empirically determined position error term,

resolving conflicts 540, in the tracking possibilities by determining the specific set of generated tracks as the result of a global optimization process that considers image data in all sensors in all cameras at once.

In Step 520 a global optimization process stitches individual tracklets into non-overlapping tracks that are consistent across all camera views. That is, tracks in specific locations are expected to appear in specific camera views, and to not appear in other camera views, and the specific set of generated tracks is the result of a global optimization process that considers image data in all sensors in all cameras at once.

In step 540, tracklets from time adjacent windows are stitched or connected together, e.g. using the Munkres Algorithm. The cost function term of the Algorithm considers spatial proximity, the position error term in spatial proximity, velocity and acceleration information deduced from the tracklet shape(s), and a variety of 2D image features related to the set of camera image pixels deduced from the reprojection of the 3D location of the track.

These 2D image features are typically:

color histogram,

height of the person, a parameter that is estimated,

pose (standing, sitting or lying),

image feature points,

the position and angle of the person's hips, shoulders and head, and

the positions of their limbs in the 2D projective space of the relevant camera images.

This is not an exhaustive set of image features and combinations. Fewer features or additional features may be used. A Bayesian approach is used to place a prior probability on height and pose, and the likelihood of feature-point, color histogram, feature points, and body position consilience across the entire track.

Once an optimal set of tracks are generated for the time adjacent window, the track is spatially smoothed for the middle window, as follows. That is, from the middle of the first half of the time adjacent window, to the middle of the second half. This allows tracklets to be stitched in parallel by considering the even windows and their successor, in parallel, and then the odd windows and their successor, in parallel. The resulting smoothed tracks then account for the position error terms in all relevant camera views.

A cloud database stores the tracks of people from the 3D map. These tracks exist regardless of whether the people entered a region or gazed at a target. An end user can draw a new region or target on the semantic map for any time since the system has started. The cloud database will match new regions and targets to old tracking data. End users can run experiments over time and locations using this capability. An “end user” may be a person, an organization, a business, or any other entity that uses the process disclosed herein. For purposes of illustration, the description below is for the case where the end user is a business.

### Analytics

In another aspect of the system, the tracks previously generated are exploited to extract some relevant analytics pertinent to the behavior of visitors and other useful information.

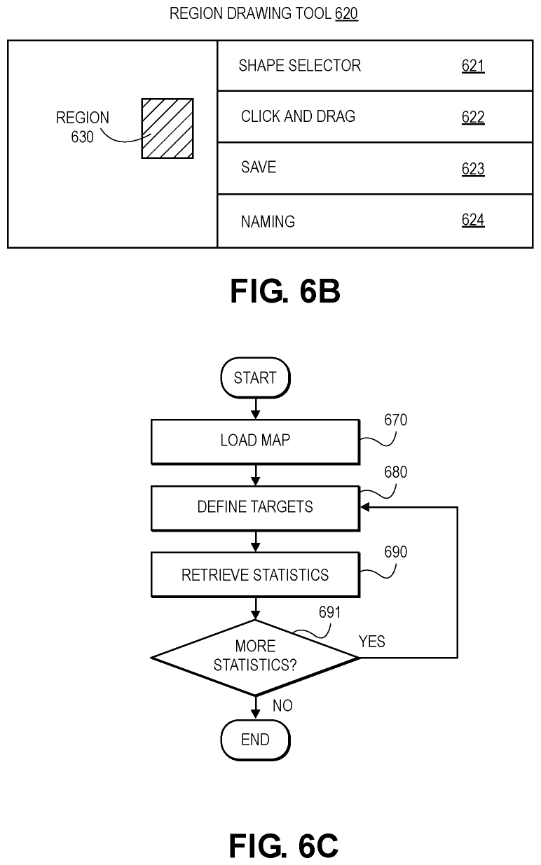

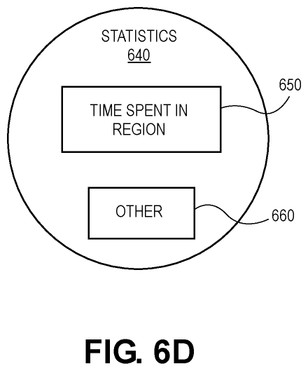

A 3D map of the room is synthesized with multiple cameras. Referring to FIG. 6A, a separate semantic map 615 is created by the business or the technician. Generally, a semantic map is considered easier to understand than a 3D map. A transformation is created between the semantic map and the 3D map using the scene file. The business can draw new regions or create new targets on the semantic map. New items are transferred to the 3D map for analysis using the transformation between the two maps.

Referring to FIG. 6A, the process 600 to obtain relevant analytics using our system operates as follows. A web map application 610 is made available to the business that has the camera system installed. The web map application 610 contains the semantic map 615 which the business can understand. This is in contrast to the 3D map which is difficult to understand. The web application is loadable on an Internet browser. As illustrated in FIG. 6B, a user (e.g., the business) can draw one or many regions of interest 630 on the semantic map. The business does not have to know where the cameras are to draw these regions 630. A region drawing tool 620 consists of a shape selector 621, a click and drag function 622, a save function 623, and a naming function 624. The tool initially displays the regions that the technician drew. The business can create new regions different from the initial ones. When the business draws a region the coordinates that it draws are translated into 3D space. There can be many overlapping regions or setups that exist at the same time.

A 2D CAD model, or other image, can be overlaid on the orthographic projection, which visually aids the end user when they create regions of interest. If no CAD image is available, then an image is synthetically produced from the multiple cameras in the scene. Also the overlay of the floor grid directly onto the sensor images, which further aids the end user when they create regions of interest.

FIG. 6C illustrates the process for retrieving statistics, comprised of the following steps: load the map in Step 670; define targets in Step 680 and retrieve statistics in Step 690, if it is determined in Step 691 that no more statistics are needed the process ends. otherwise it returns to Step 680.

As shown in FIG. 6D, statistics 640 obtained may comprise such data as the time spent 650 by a visitor in a region 630 or other relevant statistic 660. A nonexhaustive list of example statistics that may be computed and recorded include the following:

Time spent in a region during one visit

Time spent in front of a target one visit

Number of visits to a region by a particular visitor

Number of visits to a target by a particular visitor

Number of visits to a region by multiple visitors

Number of visits in front of a target by multiple visitors

Cumulative time spent in a region by multiple visitors

Cumulative time spent in front of one target in a particular day

Cumulative time spent by a particular visitor across multiple days.

The system and method described herein are capable of tracking multiple persons simultaneously. The multiple-people data may be combined to produce some of the above statistics. The statistics computed are susceptible to many variations.

### Gaze Cone

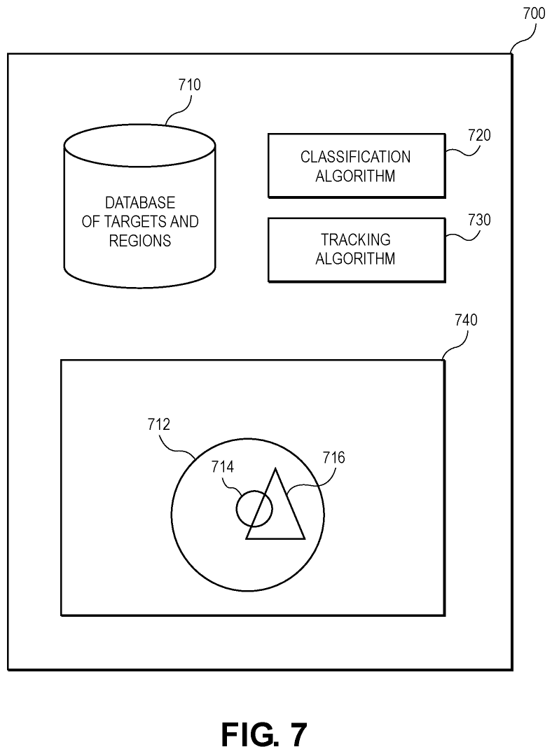

In yet another aspect of the system, the direction a visitor is looking at is estimated and, referring to FIG. 7, gaze cones 716 are defined.

Referring to FIG. 7, as a customer walks through a space they are tracked by the tracking process 700. This tracking process 700 includes the following components:

a database storage of targets and regions 710,

a gaze region 712 that is associated with each target 714 in the space 740,

targets 714,

gaze cones 716,

a classification method 720, and

a tracking method 730.

At each frame in 3D space a process determines which direction a visitor is looking at. The direction of travel and the angle of the hips, shoulders, and head are evaluated with a different weighting for each. An angle in radians—the gaze direction—is then associated with each time point of the track. The gaze direction angle gives the estimated direction the person is looking at, in the 2D orthographic view of the floor. Thus, if a person were looking precisely upwards from the floor—a practical impossibility—they would have no gaze direction, and the estimate would provide some value with high error. Most of the time, however, a person is looking in one direction across the floor, and the process accurately deduces this by examining the angles of the hips, shoulders, and head. The gaze direction determination may be done using known processes.

A gaze cone 716 is represented as a 2D triangle, orthographically projected onto the floorplan 150 where track coordinates reside. The gaze cone 716 is a set of 2D line segments that extend from the track center a specified distance. The sides of the triangle are the projection of error bars of the cone and determined using a statistical distribution. A geometric calculation is done to determine whether the gaze cone 716 intersects with the region of interest 714. The length of time that the gaze cone 716 is on the target is summed. Gaze cones are concentrated on spatially nearby items. In some implementations, a gaze (field) region 712, which is an area that includes the region of interest and an area around the region of interest, is used to define where the customer must be located for the gaze cone to activate on the region of interest 714. For those cases, two conditions must be met for the program to determine that a customer is looking at the region of interest 714: 1) the customer is located within the field/region 712, and 2) the gaze cone 716 that is constructed based on the direction of the gaze overlaps the region of interest 714. When a 2D line segment intersects with the region of interest 714, a timer begins. In some implementations, such an intersection is used alongside a track point in the field 712 where the start of the line segment is within the field 712.

### Targets

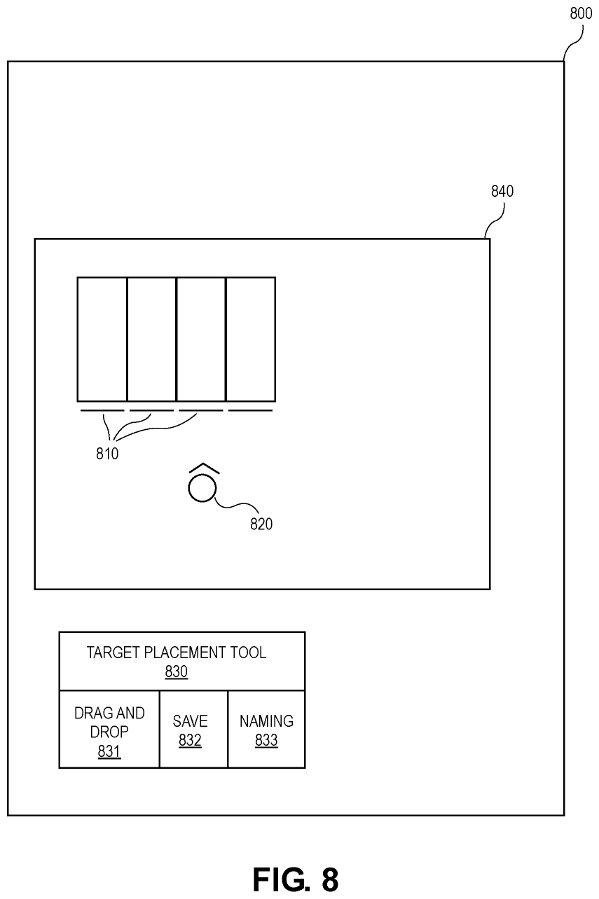

In another aspect, referring to FIG. 8, targets 810 are defined, and a tool is provided to select targets 810. Targets are useful to users of the system to direct the process in observing the most relevant actions of visitors.

Referring to FIG. 8, a process 800 for defining targets 810 in the space 840 is described. The process 800 utilizes the web map application 610, the semantic map 615 and target placement tool 830. The target 810 is an area that is smaller than a region of interest, where a customer or visitor 820 might look at. The target 810 may typically correspond to a vertical shelf, which will be typically represented by a line segment in the map 210, while a region of interest might typically correspond to a table or other furniture 220 and be represented by a shape rather than a line segment. The target placement tool 830 includes a drag and drop function 831, a naming function 833, and a save function 832. When the business places a target 810, its location is translated into 3D space. The gaze cone “lights up” a target 810 when the gaze cone and target intersect.

Using targets 810, gaze cones 716, tracks 410, extending across any rooms 110, 120, 401 and 402, and providing error correction through reduced prediction spaces 430, the system 10 enables a user to replay an entire customer or visitor visit.

The system 10 using stereo cameras to capture a comprehensive series of three dimensional and two dimensional semantic maps of a space is described in this disclosure. The system uses cameras 101 that are positioned strategically or according to a plan. The system introduces various coordinate systems to make it easier and more accurate for users to specify regions of interests 714 and targets 810. The system 10 enables users to select such regions 714 and targets 810 on a familiar 2D map. The system 10 adapts to high uncertainties in the stereo-camera-based user tracking and is capable of extracting visitor tracklets as well as tracks.

In one aspect of the tracking system 10, stereo cameras are deployed and used to create a three dimensional model of the room or multiple rooms in the space of interest. The system 10 also extracts two dimensional semantic maps for the space of interest. In another aspect of the system 10, different coordinate systems are developed to help capture the scenes and provide a convenient interface for a user to select regions of particular interest in the space. In another aspect, a UI tool is developed to assist users in selecting regions of interest. In another aspect, a method is presented to handle the high uncertainties associated with the data captured from stereo cameras. In yet another aspect, a process is developed to extract visitor tracks from camera images. In yet another aspect, the tracks previously generated are exploited to extract some relevant analytics pertinent to the behavior of visitors and other useful information. In yet another aspect, the direction a visitor is looking at is estimated and gaze cones are defined. In another aspect, targets are specified, and a tool is provided for selecting targets.

While the embodiments are described in terms of a method or technique, it should be understood that the disclosure may also cover an article of manufacture that includes a non-transitory computer readable medium on which computer-readable instructions for carrying out embodiments of the method are stored. The computer readable medium may include, for example, semiconductor, magnetic, opto-magnetic, optical, or other forms of computer readable medium for storing computer readable code. Further, the disclosure may also cover apparatuses for practicing embodiments of the inventive concept disclosed herein. Such apparatus may include circuits, dedicated and/or programmable, to carry out operations pertaining to embodiments. Examples of such apparatus include a general purpose computer and/or a dedicated computing device when appropriately programmed and may include a combination of a computer/computing device and dedicated/programmable hardware circuits (such as electrical, mechanical, and/or optical circuits) adapted for the various operations pertaining to the embodiments.

Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A computer-implemented tracking method comprising:
accessing images of a space captured by a stereo camera, wherein the space is a three-dimensional space,
generating a three-dimensional computer model of the space,
generating a two-dimensional semantic map of the space based on the three-dimensional computer model,
receiving user criteria via a user interface that includes a presentation of a room map,
extracting visitor tracks in the space of interest from the images and determining if the user criteria is fulfilled.

2. The computer-implemented tracking method of claim 1, wherein the extracting of visitor tracks is done from the stereo camera images, the method further comprising:
creating a scene file for the space, wherein the scene file describes an orthographic projection of a three-dimensional space onto a two-dimensional floor, relates the stereo camera to every other camera in the space and to a camera coordinate system, and contains at least one of: a list of cameras, a version number of the scene file, metadata, a checksum, a rigid transformation for each stereo camera, an origin of a floor space coordinate system, and calibration information for the stereo camera.

3. The computer-implemented tracking method of claim 2, further comprising mapping each pixel in the images onto a synthesized three-dimensional space recorded in the scene file.

4. The computer-implemented tracking method of claim 1, wherein the user criteria comprises a region of interest indicated on the room map of the user interface.

5. The computer-implemented tracking method of claim 1, further comprising generating tracks that represent a path of a person in the space, by:
generating a first tracklet and a second tracklet using the stereo camera, wherein the first tracklet represents a first time window and a second tracklet represents a second time window;
connecting the first tracklet and the second tracklet;
determining an overlap region between the first tracklet and the second tracklet;
choosing a tracklet portion with lowest uncertainty inside the overlap region.

6. The computer-implemented method of claim 5, wherein the connecting is based on spatial proximity of the regions depicted by the first tracklet and the second tracklet, a position error term in spatial proximity, velocity and acceleration information obtained from shape of the first tracklet and the second tracklet, and two-dimensional image features related to image pixels from the reprojection of the three-dimensional locations of the first and second tracklets.

7. The computer-implemented method of claim 6, wherein the two-dimensional image features comprise one or more of:
color histogram;
an estimated height of the person whose image is captured;
pose of the person;
image feature points;
position and angle of the person's hips, shoulders, and head; and
positions of the person's limbs in the image pixels.

8. The computer-implemented method of claim 7, further comprising determining a gaze direction of the person based on the position and angle of the person's hips, shoulders and head, and associating the gaze direction with each time point of the track.

9. The computer-implemented method of claim 8 further comprising determining that the person is looking at the region of interest by:
constructing a gaze cone extending out from a track center by a predetermined distance on a two-dimensional room map of the user interface;
constructing a field that includes the region of interest and is larger than the region of interest;
determining that the person is in the field; and
determining that the gaze cone overlaps the region of interest.

10. The computer-implemented method of claim 9 further comprising:
receiving a target in the region of interest from the user interface; and
lighting up the target if the gaze cone intersects the target.

11. The computer-implemented method of claim 9, further comprising storing the tracks and determining one or more of the following:
time spent by the person in the region of interest;
time spent in front of the target;
number of times the person visited the region of interest in a predefined time period;
number of times the person visited the target in the predefined time period;
cumulative time spent in the region of interest by multiple persons in the predefined time period; and
cumulative time spent at the target by multiple persons in the predefined time period.

12. The computer-implemented method of claim 5, further comprising applying a calibration correction process comprising:
identifying an expanded area around a portion of one track of the tracks that is captured at an edge of a camera, and determining a first geometry for the portion;
identifying a reduced prediction space around the portion that is captured by another camera and determining a second geometry for the portion; and
choosing the geometry by combining the first and second geometries.

13. The computer-implemented method of claim 1, wherein the user criteria are received in the form of selection of a region of interest on the room map, wherein the region of interest is a shape drawn on the semantic map.

14. The computer-implemented method of claim 1, wherein the user criteria received in the form of selection of a target on the room map, wherein the target is a line segment on the semantic map.

15. The computer-implemented method of claim 1, wherein the two-dimensional semantic map is related to the three dimensional computer model and the stereo camera using a rigid transformation sequence.

16. The computer-implemented method of claim 1, further comprising using a rigid transformation sequence for switching between the semantic map, the three dimensional computer model, and a stereo camera system space.

17. The computer-implemented method of claim 1, further comprising using geometric error correction in generating the two-dimensional semantic map based on the three-dimensional computer model.

18. The computer-implemented method of claim 1, further comprising tracking a visitor through the space and an adjacent space, and allowing an entire visitor's moves to be replayed.

19. The computer-implemented method of claim 1 further comprising tracking multiple persons in the space and an adjacent space, and combining individual statistics of each of the multiple persons to generate cumulative statistics.

20. The computer-implemented method of claim 1, wherein the generating of three-dimensional computer model of the space comprises performing a rigid transformation sequence to convert among Site Coordinate System, Camera Coordinate System, Scene Coordinate System, and Floor Space Coordinate System.
